(19) United States
(12) Patent Application Publication
(10) Pub. No.: US 2014/0178140 A1
(43) Pub. Date: Jun. 26, 2014

(54) CUTTING ASSEMBLY

(71) Applicant: Hougen Manufacturing, Inc., Swartz Creek, MI (US)

(72) Inventor: Jeffrey S. Gill, Davison, MI (US)

(21) Appl. No.: 14/107,299

(22) Filed: Dec. 16, 2013

Related U.S. Application Data
(60) Provisional application No. 61/740,145, filed on Dec. 20, 2012.

(51) Int. Cl. B23B 51/04

(52) U.S. Cl. CPC B23B 51/044
USPC 408/67

(57) ABSTRACT

A cutting assembly includes a cutting tool having a shank portion and a cutting portion extending axially from the shank portion, the cutting portion having a cavity extending axially therein forming an open end and defining a central axis. The cutting assembly also includes a collet disposed in the cavity for receiving and retaining a slug to be cut by the cutting portion in a workpiece after the cutting portion is withdrawn from the workpiece. The collet includes an inner contact surface with at least a portion of the inner contact surface disposed substantially non-parallel to the central axis for guiding the slug therein, and a slit extending through the collet for enabling the collet to move between an at-rest position and an expanded position to retain the slug therein.

### CROSS-REFERENCE TO RELATED APPLICATION(S)

The present invention claims the priority date of co-pending U.S. Provisional Patent Application Ser. No. 61/740,145, filed Dec. 20, 2012.

### BACKGROUND OF THE INVENTION

1. Field of the Invention

The present invention relates generally to cutting tools and, more particularly, to a cutting assembly.

2. Description of the Related Art

Cutting tools, such as annular cutters, are known in the art. Conventionally, a drill machine engages the cutter and the drill machine rotates the cutter such that the cutter cuts a hole in a workpiece. The cutter is lowered onto the workpiece for engaging the workpiece to cut the hole. A cylindrical piece, or slug, of the workpiece is formed during cutting of the hole. When conventional cutters are utilized, the slug is loose and unretained after the cutter is withdrawn from the workpiece. Having an unretained slug can create problems. In some instances, the slug may inadvertently fall within the hole cut into the workpiece. For some workpieces, such as metal piping which contains natural gas, preventing the slug from falling within the pipe is imperative. Other times, the slug may obstruct operation of the cutter if not properly retained.

It is, therefore, desirable to provide a cutting assembly to retain a slug after a cutting tool is withdrawn from a workpiece. It is also desirable to provide a cutting assembly that retains a slug and prevents the slug from inadvertently falling within a hole cut into a workpiece by a cutting tool. It is further desirable to provide a cutting assembly that retains a slug that may obstruct operation of a cutting tool if not properly retained. As such, there is a need in the art to provide a cutting assembly for retaining a slug cut from a workpiece that meets at least one of these desires.

### SUMMARY OF THE INVENTION

Accordingly, the present invention is a cutting assembly including a cutting tool having a cutting portion with a cavity extending axially therein forming an open end and defining a central axis. The cutting assembly also includes a collet disposed in the cavity for receiving and retaining a slug to be cut by the cutting portion in a workpiece after the cutting portion is withdrawn from the workpiece. The collet includes an inner contact surface with at least a portion of the inner contact surface disposed substantially non-parallel to the central axis for guiding the slug therein, and a slit extending through the collet for enabling the collet to move between an at-rest position and an expanded position to retain the slug therein.

One advantage of the present invention is that a new cutting assembly is provided for retaining a slug to be cut from a workpiece. Another advantage of the present invention is that the cutting assembly retains a slug after a cutting tool is withdrawn from the workpiece. Yet another advantage of the present invention is that the cutting assembly prevents the slug from inadvertently falling within a hole cut into the workpiece by the cutting tool. Still another advantage of the present invention is that the cutting assembly may be used on various workpieces, such as metal piping which contains natural gas, preventing the slug from falling within the piping. A further advantage of the present invention is that the cutting assembly retains the slug to prevent obstructed operation of the cutting assembly.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a cross-sectional view of a drill machine including one embodiment of a cutting assembly, according to the present invention, extending from the drill machine for cutting a workpiece.

FIG. 2 is a side view of the cutting assembly of FIG. 1.

FIG. 3 is a cross-sectional view of another embodiment of the cutting assembly, according to the present invention, of FIGS. 1 and 2.

FIG. 4 is a cross-sectional view of the cutting assembly of FIG. 2.

FIG. 5a is a perspective view of one embodiment of a collet, according to the present invention, of the cutting assembly of FIGS. 1 through 4.

FIG. 5b is a cross-sectional view of the collet of FIG. 5a.

FIG. 5c is a side view of the collet of FIG. 5b.

FIG. 5d is a front view of the collet of FIG. 5a illustrating the collet in an expanded position.

FIG. 5e is a front view of the collet of FIG. 5a illustrating the collet in an at-rest position.

FIG. 5f is a front view of the collet of FIG. 5a illustrating the collet in a constricted position.

FIG. 6 is a cross-sectional view of the cutting assembly of FIGS. 2 and 4 illustrating the collet of FIG. 5a disposed therein and a slug disposed outside thereof.

FIG. 7 is a cross-sectional view of another embodiment of the cutter assembly, according to the present invention, of FIGS. 2 and 4 illustrating the collet disposed therein and a slug disposed outside thereof.

FIG. 8 is a cross-sectional view of the cutting assembly of FIG. 6 illustrating the slug being retained by the collet of the cutting assembly.

FIG. 9 is a cross-sectional view of the cutting assembly of FIG. 7 illustrating the slug being retained by the collet of the cutting assembly.

### DETAILED DESCRIPTION OF THE PREFERRED EMBODIMENT(S)

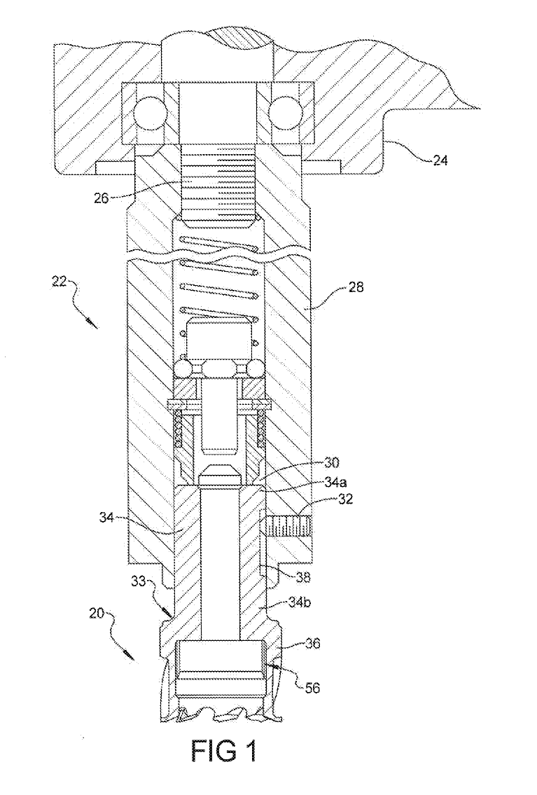

Referring to the Figures, wherein like numerals indicate like parts throughout the several views, one embodiment of a cutting assembly, according to the present invention, is shown generally at 20. The cutter assembly 20 is configured to cut a hole in a workpiece (not shown). As illustrated in FIG. 1, a drill machine 22 engages the cutting assembly 20 and rotates the cutting assembly 20 for cutting the hole. The drill machine 22 typically includes a housing 24 and a motor 26 (partially shown) which creates rotation. An arbor 28 is attached to the housing 24 for coupling the cutting assembly 20 to the drill machine 22. The arbor 28 is coupled to the motor 26 such that the motor 26 rotates the arbor 28. The arbor 28 defines a bore 30 and a retention device 32 is coupled to the arbor 28 and extends into the bore 30. The cutting assembly 20 is inserted partially into the bore 30 and is coupled to the arbor 28 by the retention device 32. As the arbor 28 rotates, the cutting assembly 20 rotates. As such, the drill machine 22 is configured to rotate the cutting assembly 20. It should be appreciated that the drill machine 22 shown in FIG. 1 is not intended to limit the scope of the invention. It should also be appreciated that the cutting assembly 20 may operate with various other types of drill machines 22, including various types of retention devices 32, not specifically shown herein.

The cutting assembly 20 partially extends from the bore 30 of the arbor 28 for cutting the workpiece. The workpiece is formed typically from a rigid material such as wood, plastic, or metal. One example of the workpiece is metal piping such as a metal pipe. The cutting assembly 20 rotates relative to the housing 24 of the drill machine 22 to cut the hole in the workpiece. The cutting assembly 20 may be formed of metal, and more specifically, steel. It should be appreciated that the cutting assembly 20 can be formed from other rigid materials without departing from the nature of the present invention.

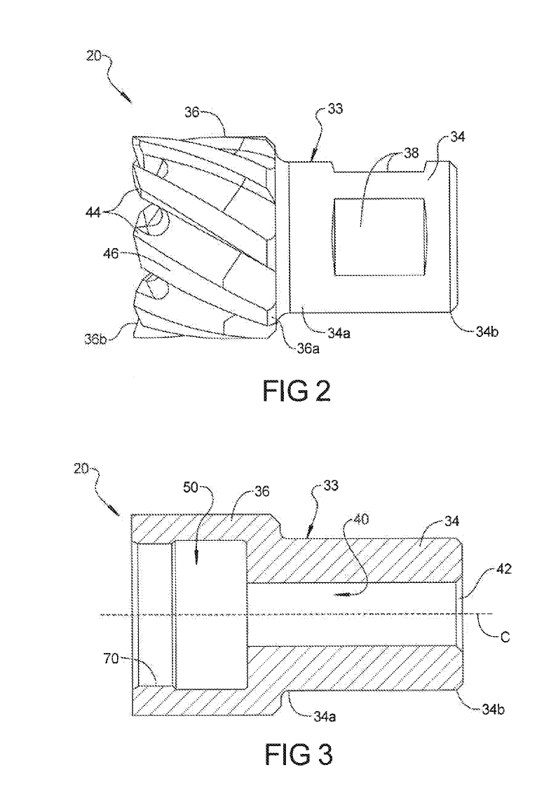

As illustrated in FIGS. 1 and 2, the cutting assembly 20 generally has a cylindrical or ring-shaped configuration. As such, the cutting assembly 20 may be referred to in the industry as an annular cutting assembly 20. The cutting assembly 20 includes a cutting tool, generally indicated at 33 and according to one embodiment of the present invention, having a shank portion 34 and a cutting portion 36 which is adjacent the shank portion 34. The shank portion 34 is configured to couple the cutting assembly 20 to the arbor 28 of the drill machine 22. The cutting portion 36 is configured to interface with and cut the hole in the workpiece. As illustrated in FIG. 3, the shank portion 34 and the cutting portion 36 may be formed from a single integrally formed piece or blank. In another embodiment, the shank portion 34 and the cutting portion 36 may be separately formed. As illustrated in FIG. 3, the cutting assembly 20 defines a central axis C of rotation. The central axis C passes through the shank portion 34 and the cutting portion 36. As such, the shank portion 34 and cutting portion 36 extend along the central axis C.

Referring to FIG. 2, the shank portion 34 has a first shank end 34a and a second shank end 34b. The cutting portion 36 is adjacent to the first shank end 34a. The second shank end 34b is inserted into the bore 30 and coupled to the arbor 28 such that drill machine 22 can rotate the cutter assembly 20. As illustrated in FIG. 1, the retention device 32 engages the shank portion 34 to enable the cutting assembly 20 to rotate with the arbor 28. Specifically, the retention device 32 engages the shank portion 34 between the first and second shank ends 34a, 34b. The retention device 32 may have any suitable configuration. In one embodiment illustrated in FIG. 1, the retention device 32 includes at least one set screw for engaging the shank portion 34. The shank portion 34 may include a planar structure or flat 38 to facilitate engagement between the retention device 32 and the shank portion 34. In one embodiment illustrated in FIG. 2, the shank portion 34 includes two flats 38 which are spaced 90 degrees apart from one another with respect to a cross-section of the shank portion 34. The shank portion 34 may be coupled to the drill machine 22 according to other methods without departing from the nature of the present invention. Furthermore, the shank portion 34 may have a cross-sectional diameter of any suitable size. In one embodiment illustrated in FIG. 2, the cross-sectional diameter of the shank portion 34 is approximately 0.75 inches. It should be appreciated that the shank portion 34 of the cutting tool 33 is optional and the cutting portion 36 of the cutting tool 33 may be coupled to the drill machine 22 according to other methods or driven by other mechanisms such as a threaded arbor (the cutting portion 36 with a female thread and the arbor with a male thread) or a “D” drive arbor (cutting portion 36 with a “D” drive slot and the arbor with a male mating configuration) without departing from the nature of the present invention.

The shank portion 34 presents generally a cylindrical surface extending circumferentially about the central axis C. As illustrated in FIG. 3, a channel 40 is defined through the shank portion 34 along the central axis C between the first and second shank ends 34a, 34b. The channel 40 generally has a cylindrical configuration. However, the channel 40 may have other configurations, such as a rectangular configuration, without departing from the scope of the invention. In one embodiment illustrated in FIG. 3, the channel 40 has a cross-sectional diameter of approximately 0.315 inches. The shank portion 34 may include a shank taper 42 disposed at the second shank end 34b. The shank taper 42 defines a width along the central axis C and increases the cross-sectional diameter of the channel 40 along the width of the shank taper 42. The shank taper 42 helps guide the shank portion 34 in relation to the drill machine 22.

As mentioned above, the cutting portion 36 is adjacent the first shank end 34a. In instances where the shank portion 34 and the cutting portion 36 are integrally formed, the cutting portion 36 extends integrally from the first shank end 34a. In another embodiment, in instances where the cutting portion 36 is formed separate from the shank portion 34, the cutting portion 36 may be attached to the first shank end 34a using any suitable method.

Referring to FIGS. 2 through 4, the cutting portion 36 includes a first cutting end 36a and a second cutting end 36b. The first cutting end 36a is adjacent the first shank end 34a. The second cutting end 36b is configured to engage the workpiece. Specifically, as illustrated in FIG. 2, the second cutting end 36b includes a plurality of serrations or teeth 44 for cutting the hole in the workpiece. The teeth 44 include axial end faces 46 which are generally inclined radially between the first and second cutting ends 36a, 36b. The axial end faces 46 of the teeth 44 typically are evenly spaced.

The cutting portion 36 includes generally a cylindrical surface extending circumferentially about the central axis C between the first and second cutting ends 36a, 36b. In one embodiment illustrated in FIG. 2, the cutting portion 36 has a cross-sectional diameter which is larger than the cross-sectional diameter of the shank portion 34. For instance, the cross-sectional diameter of the cutting portion 36 may be approximately one inch while the cross-sectional diameter of the shank portion 34 may be approximately 0.75 inches. In such instances, the cutting assembly 20 is configured to cut holes having a one inch diameter. In another embodiment, the cross-sectional diameters of the cutting portion 36 and the shank portion 34 may be substantially equivalent. The cross-sectional diameter of the cutting portion 36 may have various other dimensions without departing from the nature of the present invention. The cross-sectional diameter of the cutting portion 36 may also be known as the inner diameter (ID) of the cutting portion 36.

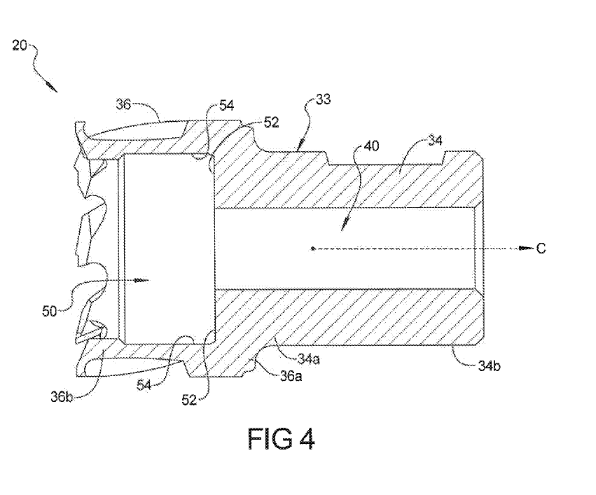

Referring to FIGS. 3 and 4, a cavity 50 is defined through the cutting portion 36 along the central axis C between the first and second cutting ends 36a, 36b. As illustrated in FIG. 4, the cavity 50 is defined between a back wall 52 and a side wall 54 of the cutting portion 36. The back wall 52 is adjacent to the channel 40. In one embodiment, the back wall 52 has a circular configuration. The side wall 54 is adjacent and perpendicular to the back wall 52. The side wall 54 has a cylindrical configuration. As such, the cavity 50 generally has a cylindrical configuration with an open end opposite the back wall 52.

In one embodiment, the cavity 50 has a cross-sectional diameter that is larger than the cross-sectional diameter of the channel 40. For example, in FIG. 3, the cross-sectional diameter of the cavity 50 may be approximately 0.74 inches while the cross-sectional diameter of the channel 40 may be approximately 0.315 inches. In such instances, the cross-sectional diameter of the cavity 50 is more than double the cross-sectional diameter of the channel 40. However, the cross-sectional diameters of the channel 40 and the cavity 50 may be other sizes without departing from the scope of the invention.

The channel 40 of the shank portion 34 opens into the cavity 50 of the cutting portion 36. In one embodiment illustrated in FIGS. 3 and 4, the channel 40 extends beyond the first shank end 34a and into the cutting portion 36. In other words, the channel 40 extends beyond the first cutting end 36a. In another embodiment, the channel 40 extends only between the first and second shank ends 34a, 34b and the cavity 50 extends only between the first and second cutting ends 36a, 36b. The channel 40 and the cavity 50 may be arranged and dimensioned according to other configurations not specifically described herein.

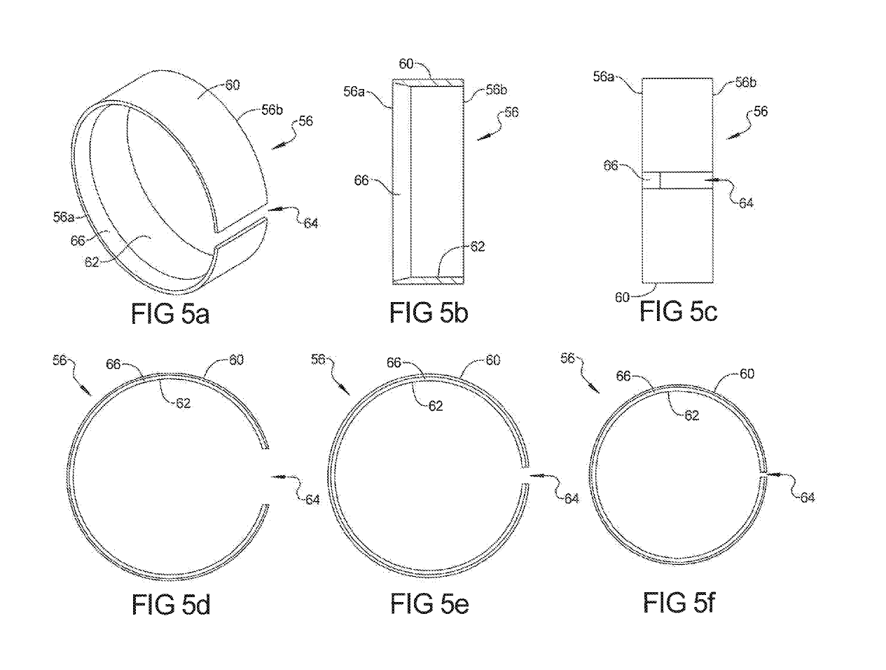

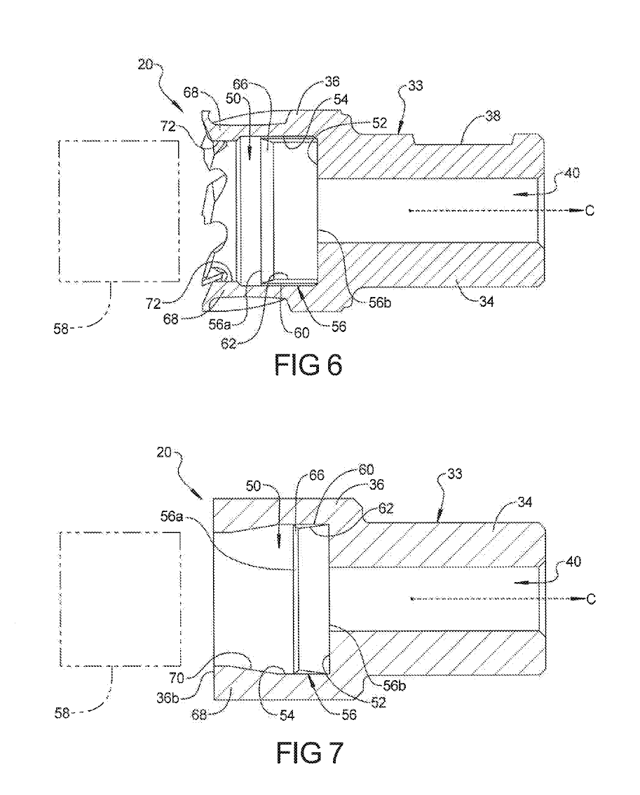

Referring to FIGS. 5 through 7, the cutting assembly 20 includes a collet, generally indicated at 56 and according to one embodiment of the present invention, cooperating with the cutting tool 33. As illustrated in FIGS. 6 and 7, the collet 56 is disposed in the cavity 50 of the cutting portion 36. As discussed, the cutting assembly 20 penetrates the workpiece to make the hole. After the cutting assembly 20 is withdrawn from the workpiece, a cylindrical piece, or slug 58, of the workpiece is created when forming the hole. As will be described in greater detail below, the collet 56 retains the slug 58 after the cutting assembly 20 is withdrawn from the workpiece.

As illustrated in FIGS. 5a, 5b, 6, and 7, the collet 56 includes an entry face 56a and a rear face 56b. The slug 58 enters the collet 56 through the entry face 56a. The collet 56 is typically disposed in the cavity 50 such that the rear face 56b of the collet 56 faces the back wall 52 of the cutting portion 34. In one embodiment, the rear face 56b abuts the back wall 52 of the cavity 50. In another embodiment, the rear face 56b may be spaced from the back wall 52 of the cavity 50.

As illustrated in FIG. 5a, the collet 56 has an annular configuration with an outer contact surface 60 and an inner contact surface 62. The collet 56 defines a thickness between the inner and outer contact surfaces 60, 62. The inner contact surface 62 has at least a portion disposed substantially non-parallel to the central axis C. In the embodiment illustrated in FIG. 5a, the collet 56 is annular with a ring-shaped configuration. In this embodiment, the outer contact surface 60 is equally radially spaced from a radial center of the collet 56, and the inner contact surface 62 is equally radially spaced from the radial center of the collet 56. In other words, the inner and outer contact surfaces 60, 62 are disposed substantially parallel to the central axis C when the collet 56 is disposed in the cavity 50 of the cutting portion 36. In another embodiment illustrated in FIG. 7, the collet 56 is annular with a conical configuration. In this embodiment, each of the outer and inner contact surfaces 60, 62 are gradually inclined and/or declined and radially spaced from the radial center of the collet 56 according to varying distances. In other words, the inner and outer contact surfaces 60, 62 are disposed substantially non-parallel to the central axis C when the collet 56 is disposed in the cavity 50 of the cutting portion 36. It should be appreciated that the inner contact surface 62 may be disposed substantially non-parallel to the central axis C when the collet 56 is disposed in the cavity 50 of the cutting portion 36 while the outer contact surface 60 may be disposed substantially parallel to the central axis C when the collet 56 is disposed in the cavity 50 of the cutting portion 36. It should also be appreciated that the collet 56 may have other annular configurations not specifically shown or described herein without departing from the scope of the present invention.

In one embodiment illustrated in FIGS. 5a through 5f, the collet 56 includes a slit 64 which severs the ring configuration of the collet 56 at a predetermined point. With the slit 64, the collet 56 defines a cross-section having generally a C-shape configuration. In FIG. 5e, the collet 56 is in an at-rest position. The slit 64 enables the collet 56 to flex between the at-rest position and an expanded position shown in FIG. 5d. In the expanded position, the slit 64 widens. The slit 64 further enables the collet 56 to flex between the at-rest position and a constricted position shown in FIG. 5f. In the constricted position, the slit 64 narrows. In either instance, the collet 56 is biased towards the at-rest position. The slit 64 may be formed according to any suitable method, such as by cutting the collet 56 with a band saw. The collet 56 may employ other methods other than the slit 64 for enabling the collet 56 to flex between the constricted, at-rest, and expanded positions. Furthermore, the collet 56 may be formed of any suitable material for enabling the collet 56 to flex, including, but not limited to steel, such as 4140 alloy steel.

As illustrated in FIG. 5c, the collet 56 has an outer diameter corresponding to the outer contact surface 60. In FIG. 5c, the outer diameter of the collet 56 is approximately 0.725 inches in the at-rest position. As illustrated in FIG. 5b, the collet 56 has an inner diameter corresponding to the inner contact surface 62. In FIG. 5b, the inner diameter of the collet 56 is approximately 0.679 inches in the at-rest position. FIG. 5d illustrates the collet 56 in the expanded position as compared to when the collet 56 is in the at-rest position as shown in FIG. 5e. In the expanded position, the inner and outer diameters of the collet 56 increase relative to the at-rest position. FIG. 5f illustrates the collet 56 in the constricted position as compared to when the collet 56 is in the at-rest position as shown in FIG. 5e. In the constricted position, the inner and outer diameters of the collet 56 decrease relative to the at-rest position. In instances where the collet 56 has a conical type configuration, the inner and outer diameters of the collet 56 may vary in dimension along the width of the collet 56.

As illustrated in FIG. 5c, the collet 56 also has a width extending along the central axis C. In one embodiment, the width is approximately 0.25 inches. The width of the collet 56 may be configured to correspond to a thickness of the workpiece such that the collet 56 substantially surrounds the slug 58 when the collet 56 retains the slug 58. Alternatively, the width of the collet 56 may be less than the thickness of the workpiece such that the collet 56 surrounds only a portion of the slug 58.

In the at-rest position, the inner diameter of the collet 56 is configured such that it is slightly smaller than the cross-sectional diameter of the slug 58. In one embodiment, the cross-sectional diameter of the slug 58 is 0.685 inches and the inner diameter of the collet 56 at-rest is 0.679 inches. As will be described below, having the inner diameter of the collet 56 smaller than the cross-sectional diameter of the slug 58 facilitates retention of the slug by the collet 56. In instances where the collet 56 has a conical configuration, the inner diameter of the collet 56 may be configured to be slightly smaller than the cross-sectional diameter of the slug 58 at the entry face 56a of the collet 56.

The outer diameter of the collet 56 is configured such that the collet 56 fits into the cavity 50 in the at-rest position. In the expanded position, the outer diameter of the collet 56 is configured such that it is slightly smaller than the cross-sectional diameter of the cavity 50. In one example, the outer diameter of the collet 56 may be approximately 0.725 inches and the cross-sectional diameter of the cavity 50 may be approximately 0.74 inches. This allows clearance between the outer contact surface 60 of the collet 56 and the side wall 54 of the cutting portion 36. Such clearance is needed to allow the collet 56 to freely expand when retaining the slug 58. Failure to provide such clearance may result in the collet 56 forcibly pressing on the side wall 54 of the cutting portion 36 which may cause damage to or break the cutting portion 36. The outer contact surface 60 may intermittently abut the side wall 54 of the cutting portion 36 such that the collet 56 is secured in the cavity 50, but may freely rotate within the cavity 50.

Referring to FIGS. 5a and 5b, the collet 56 may include a collet taper 66 formed into the inner contact surface 62 and disposed at the entry face 56a of the collet 56. The collet taper 66 defines a width along the central axis C and is substantially non-parallel to the central axis C. In FIG. 5b, the width of the collet taper 66 is 0.06 inches and extends across approximately 25% of the width of the collet 56. The collet taper 66 increases the inner diameter of the collet 56 along the width of the collet taper 66. In one embodiment, the collet taper 66 increases the inner diameter of the collet 56 by 4-5%. The collet taper 66 guides the slug 58 and provides the slug 58 with flexibility when entering the collet 56.

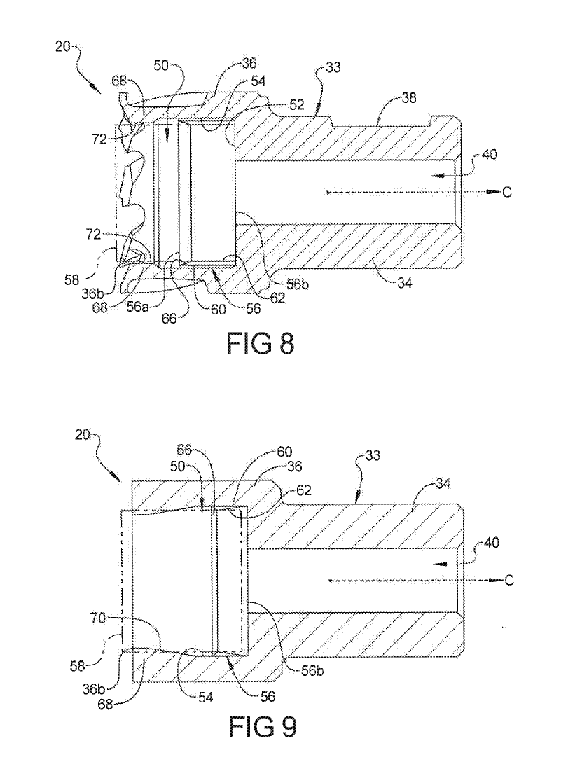

As the workpiece is cut by the cutting portion 36, the slug 58 enters the open end of the cavity 50 of the cutting portion 36. The slug 58 continues through the cavity 50 and eventually enters the collet 56 as illustrated in FIGS. 8 and 9. As the slug 58 enters the collet 56, the slug 58 may abut the collet taper 66. The collet taper 66 guides the slug 58 into the collet 56. Since the inner diameter of the collet 56 is smaller than the cross-sectional diameter of the slug 58, the collet 56 gradually flexes from the at-rest position into the expanded position as the slug 58 enters the collet 56. Eventually, the inner contact surface 62 of the collet 56 surrounds the slug 58. The slug 58 applies a force to the inner contact surface 62 to flex the collet 56 in the expanded position. From the expanded position, the collet 56 biases towards the at-rest position. In doing so, the inner contact surface 62 applies a biasing force to the slug 58 thereby retaining the slug 58. As such, the slug 58 is retained by the collet 56 as the cutting assembly 20 is withdrawn from the workpiece.

Referring to FIGS. 8 and 9, the cutting tool 33 includes a protrusion 68 disposed in the cavity 50 of the cutting portion 36 which is configured to retain the collet 56 in the cavity 50. The protrusion 68 extends into the cavity 50 from the side wall 54. In one embodiment illustrated in FIG. 8, the protrusion 68 is formed about the central axis C such that the protrusion 68 is annular. In another embodiment illustrated in FIG. 9, the protrusion 68 extends from the side wall 54 only at predetermined positions necessary to retain the collet 56. In one embodiment, the protrusion 68 may be integrally formed into the side wall 54 of the cavity 50. In another embodiment, the protrusion 68 may be a separate component which is attached to the side wall 54. The protrusion 68 defines a width extending through the cavity 50 along the central axis C. In one embodiment, the width of the protrusion 68 is approximately 0.19 inches.

The protrusion 68 also actively engages the workpiece for cutting the hole. The protrusion 68 further reduces the cross-sectional diameter of the cavity 50 for retaining the collet 56 within the cavity 50. As illustrated in FIGS. 6 through 9, the slug 58 has a cross-sectional diameter typically corresponding to the inner cross-sectional diameter defined in the cavity 50 between the protrusion 68. The inner cross-sectional diameter of the cavity 50 is reduced along the width of the protrusion 68. In the embodiment illustrated in FIG. 3, the inner cross-sectional diameter defined in the cavity 50 between the protrusion 68 is approximately 0.69 inches.

In one embodiment, the collet 56 is retained in the cavity 50 between the protrusion 68, the back wall 52, and the side wall 54. The protrusion 68 reduces the cross-sectional diameter of the cavity 50 to an extent necessary to allow the collet 56 to pass through the cavity 50 when the collet 56 is in the constricted position. For example, the protrusion 68 may reduce the cross-sectional diameter of the cavity 50 by 5%. Likewise, the collet 56 may be configured such that the inner diameter of the collet 56 reduces by 5% when the collet 56 is in the constricted position as compared to the at-rest position. As such, the collet 56 would need to be flexed into the constricted position in order to pass through the cavity 50 at the protrusion 68. After the collet 56 passes by the protrusion 68 in the constricted position, the collet 56 may expand in the cavity 50 from the constricted position to the at-rest position. Once the collet 56 expands to the at-rest position, the inner diameter of the collet 56 will be larger than the cross-sectional diameter of the cavity 50 that is reduced by the protrusion 68. As such, the protrusion 68 prevents the collet 56 from exiting the cavity 50. In such instances, the collet 56 may move freely along the central axis C between the protrusion 68 and the back wall 52. Alternatively, the collet 56 may be secured in a fixed position between the protrusion 68 and the back wall 52. The collet 56 may enter the cavity 50 according to methods other than flexing the collet 56 in the constricted position.

In one embodiment illustrated in FIGS. 7 and 9, the protrusion 68 is further defined as a protrusion taper 70. The second cutting end 36b may include the protrusion taper 70 extending into the cutting portion 36 for providing cutting relief between the cutting assembly 20 and the workpiece. The protrusion taper 70 further provides support in the retention of the slug 58 during retraction of the cutting assembly 20 from the workpiece. The protrusion taper 70 may have various configurations. For example, the protrusion taper 70 may have a ramp configuration whereby the protrusion taper 70 has a linear profile which inclines from the side wall 54. In such instances, the protrusion taper 70 extends from the side wall 54 according to a predetermined angle. In one embodiment, the protrusion taper 70 extends from the side wall 54 at an 11 degree angle. In another embodiment, the protrusion taper 70 may have an arcuate or contoured configuration.

In one embodiment illustrated in FIGS. 6 and 8, the protrusion 68 is further defined as a step 72. In such embodiments, the protrusion 68 has a linear profile which is substantially parallel to the central axis C. The step 72 is elevated from the side wall 54 and extends into the cavity 50 such that the step 72 prevents the collet 56 from exiting the cavity 50.

The present invention further provides a method of retaining a slug 58 created from cutting a hole in a workpiece. The method includes the step of providing a cutting assembly 20 which defines a cavity 50 with a protrusion 68 extending into the cavity 50. A collet 56 is placed within the cavity 50 adjacent to the protrusion 68 such that the collet 56 is secured in the cavity 50. The cutting assembly 20 is engaged with the workpiece for creating the hole. The slug 58 enters the cavity 50 of the cutting assembly 20 during engagement with the workpiece. The slug 58 enters the collet 56 such that the collet 56 engages the slug 58. The cutting assembly 20 is withdrawn from the workpiece. The collet 56 retains the slug 58 such that the slug 58 is withdrawn with the cutting assembly 20.

The method may further include the step of removing the slug 58 from the cutting assembly 20. In one embodiment, the slug 58 may be removed by a tool (not shown), such as a rod, which is separate from the cutter assembly 20 and drill machine 22. The tool is forced through the channel 40 at the second shank end 34b. The tool passes through the channel 40 until the tool abuts the slug 58 which is retained by the collet 56 in the cavity 50. The tool is utilized to apply force to the slug 58 for disengaging the slug 58 from the collet 56. Thereafter, the slug 58 can be removed from the cavity 50. In another embodiment, the entire cutting assembly 20 may be removed from the drill machine 22 and discarded after the slug 58 is retained by the collet 56. A replacement cutting assembly 20 having a replacement collet 56 disposed therein may be reattached to the drill machine 22.

Furthermore, the present invention may be utilized where the drill machine 22 and the arbor 28 include a lubrication system. In such configurations, the channel 40 and cavity 50 of the cutting assembly 20 slideably receive a pilot pin which extends along the central axis C. When the cutting assembly 20 contacts the workpiece, the pilot pin is forced upwardly to allow lubricant to flow from the arbor 28 toward the workpiece. The pilot pin may be disposed through the collet 56. The cutting assembly 20 and method of the present invention may be utilized with such lubrication systems without departing from the scope of the invention.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A cutting assembly comprising:
a cutting tool including a cutting portion having a cavity extending axially therein forming an open end and defining a central axis; and
a collet disposed in said cavity for receiving and retaining a slug to be cut by said cutting portion in a workpiece after said cutting portion is withdrawn from the workpiece, said collet including an inner contact surface with at least a portion of said inner contact surface disposed substantially non-parallel to said central axis for guiding the slug therein and a slit extending through said collet for enabling said collet to move between an at-rest position and an expanded position to retain the slug therein.

2. A cutting assembly as set forth in claim 1 including a protrusion extending from said cutting portion for retaining said collet in said cavity.

3. A cutting assembly as set forth in claim 2 wherein said protrusion extends toward said central axis.

4. A cutting assembly as set forth in claim 2 wherein said protrusion extends into said cavity.

5. A cutting assembly as set forth in claim 1 wherein said collet has an annular configuration.

6. A cutting assembly as set forth in claim 5 wherein said collet has an outer contact surface spaced from said inner contact surface.

7. A cutting assembly as set forth in claim 6 wherein said outer contact surface is disposed substantially parallel to said central axis when said collet is disposed in said cavity.

8. A cutting assembly as set forth in claim 6 wherein said outer contact surface is disposed substantially non-parallel to said central axis when said collet is disposed in said cavity.

9. A cutting assembly as set forth in claim 1 wherein said at least a portion of said inner contact surface has a diameter less than a diameter of the slug.

10. A cutting assembly as set forth in claim 1 wherein said shank portion and said cutting portion are integral and one-piece.

11. A cutting assembly comprising:
a cutting tool having a shank portion and a cutting portion extending axially from said shank portion, said cutting portion including a closed end and an open end, said closed end being adjacent said shank portion and said open end having a plurality of teeth for cutting a hole in a workpiece and a cavity extending axially from said first end toward said second end and defining a central axis;
a collet disposed in said cavity for receiving and retaining a slug to be cut by said cutting portion in the workpiece after said cutting portion is withdrawn from the workpiece, said collet including an inner contact surface with at least a portion of said inner contact surface disposed substantially non-parallel to said central axis for guiding the slug therein and a slit extending through said collet for enabling said collet to move between an at-rest position and an expanded position to retain the slug therein; and
a protrusion extending from said cutting portion for retaining said collet in said cavity.

12. A cutting assembly as set forth in claim 11 wherein said protrusion extends toward said central axis.

13. A cutting assembly as set forth in claim 11 wherein said protrusion extends into said cavity.

14. A cutting assembly as set forth in claim 11 wherein said collet has an annular configuration.

15. A cutting assembly as set forth in claim 14 wherein said collet has an outer contact surface spaced from said inner contact surface.

16. A cutting assembly as set forth in claim 15 wherein said outer contact surface is substantially parallel to said central axis when said collet is disposed in said cavity.

17. A cutting assembly as set forth in claim 15 wherein said outer contact surface is substantially non-parallel to said central axis when said collet is disposed in said cavity.

18. A cutting assembly as set forth in claim 11 wherein said at least a portion of said inner contact surface has a diameter less than a diameter of the slug.

19. A cutting assembly as set forth in claim 11 wherein said shank portion and said cutting portion are integral and one-piece.

20. A cutting assembly connectable to a drilling assembly for retaining a slug cut from a workpiece, said cutting assembly comprising:
a shank portion for engaging the drilling assembly and a cutting portion for interfacing with the workpiece;
said shank portion and said cutting portion being formed from a single integrally formed piece and aligned along a central axis of rotation, said cutting portion having a cavity with a diameter being defined within said cutting portion along said central axis;
a collet in said cavity, said collet having an annular configuration with an inner diameter, an outer diameter, and a taper for guiding the slug, said collet including a slit for enabling said collet to move between a constricted position, an at-rest position and an expanded position, said collet moving from said at-rest position to said expanded position to retain the slug as the slug enters said collet;
a protrusion integrally extending from said cutting portion for reducing the diameter of said cavity;
wherein said outer diameter of said collet in said constricted position is less than the diameter of the cavity reduced by said protrusion such that said collet bypasses said protrusion for allowing said collet to enter said cavity when said collet is in the constricted position; and
wherein said outer diameter of said collet in said at-rest position is greater than the diameter of said cavity reduced by said protrusion such that said collet is retained in said cavity by said protrusion when said collet is in said at-rest position.
